(19) United States
(12) Patent Application Publication
(10) Pub. No.: US 2011/0053582 A1
(43) Pub. Date: Mar. 3, 2011

(54) END-USER DEVICES AND METHODS FOR CONTROLLING AN END-USER DEVICE

(75) Inventors: Markus Dominik Mueck, Unterhaching (DE); Maik Bienas, Braunschweig (DE); Andreas Schmidt, Braunschweig (DE)

(73) Assignee: INFINEON TECHNOLOGIES AG, Neubiberg (DE)

(21) Appl. No.: 12/548,544

(22) Filed: Aug. 27, 2009

(51) Int. Cl. H04M 3/00

(52) U.S. Cl. 455/419

(57) ABSTRACT

In an embodiment, an end-user mobile device is provided. The end-user mobile device may include a transmitter configured to broadcast context information based on the occurrence of a pre-determined event.

### TECHNICAL FIELD

The present invention relates generally to end-user devices and methods for controlling an end-user device.

### BACKGROUND

Cellular communication systems usually exploit a wireless link between User Equipment (UE) and Base-Stations (BS) in order to exchange information.

In recent mobile communication networks, usually a wide variety of different access technologies is available.

In this scenario, the Cognitive Pilot Channel (as it is under discussion within the ETSI RRS (European Telecommunications Standards Institute Reconfigurable Radio Systems) standardization group, for example), is broadcasting context information on a dedicated physical channel that helps the various user devices to know which communication standards are available (without requiring the handsets to scan for all possibilities). The Cognitive Pilot Channel is operated by one or more network operators. Typically, the user will be informed about the presence of cellular mobile radio communication systems (also referred to as Cellular Wide Area radio communication systems), metropolitan area mobile radio communication systems (also referred to as Metropolitan Area System radio communication systems) and/or short range mobile radio communication systems (also referred to as Short Range radio communication systems) and based on the context, the user device may choose a reconfiguration of its device.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a radio communication system in accordance with an embodiment;

FIG. 2 shows an end-user mobile device in accordance with an embodiment;

FIG. 3 shows an end-user mobile device in accordance with an embodiment;

FIG. 4 shows an end-user mobile device in accordance with an embodiment;

FIG. 5 shows an end-user mobile device in accordance with an embodiment;

FIG. 6 shows a flow diagram illustrating a method for controlling an end-user mobile device in accordance with an embodiment;

FIG. 7 shows a flow diagram illustrating a method for controlling an end-user mobile device in accordance with an embodiment;

FIG. 8 shows a communication system in accordance with an embodiment;

FIG. 9 shows a flow diagram illustrating a method for controlling a communication system in accordance with an embodiment;

FIG. 10 shows a communication device in accordance with an embodiment;

FIG. 11 shows an example of a communication system where a three-hop communication in performed in accordance with an embodiment;

FIG. 12 shows a radio communication system in accordance with an embodiment;

FIG. 13 shows a radio communication system in accordance with an embodiment;

FIG. 14 shows a radio communication system in accordance with an embodiment; and

FIG. 15 shows a radio communication system in accordance with an embodiment.

### DESCRIPTION

The following detailed description refers to the accompanying drawings that show, by way of illustration, specific details and embodiments in which the invention may be practiced. These embodiments are described in sufficient detail to enable those skilled in the art to practice the invention. In this regard, directional terminology, such as “top”, “bottom”, “front”, “back”, “leading”, “trailing”, etc, is used with reference to the orientation of the Figure(s) being described. Because components of embodiments can be positioned in a number of different orientations, the directional terminology is used for purposes of illustration and is in no way limiting. Other embodiments may be utilized and structural, logical, and electrical changes may be made without departing from the scope of the invention. The various embodiments are not necessarily mutually exclusive, as some embodiments can be combined with one or more other embodiments to form new embodiments. The following detailed description therefore, is not to be taken in a limiting sense, and the scope of the present invention is defined by the appended claims.

The word “exemplary” is used herein to mean “serving as an example, instance, or illustration”. Any embodiment or design described herein as “exemplary” is not necessarily to be construed as preferred or advantageous over other embodiments or designs.

An end-user mobile device according to various embodiments may be a device configured for wireless communication. In various embodiments, an end-user mobile device may be any kind of mobile telephone, personal digital assistant, mobile computer, or any other mobile device configured for communication with a mobile communication base station or an access point and may be also referred to as a User Equipment (UE). In various embodiments, an end-user mobile device may be a femto cell base station or a Home Node B base station.

The end-user mobile devices (MD) according to various embodiments may include a memory which is for example used in the processing carried out by the end-user mobile devices. A memory used in the embodiments may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

In an embodiment, a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “circuit” may also be a processor executing software, e.g. any kind of computer program, e.g. a computer program using a virtual machine code such as e.g. Java. Any other kind of implementation of the respective functions which will be described in more detail below may also be understood as a “circuit” in accordance with an alternative embodiment.

The terms “coupling” or “connection” are intended to include a direct “coupling” or direct “connection” as well as an indirect “coupling” or indirect “connection”, respectively.

The term “protocol” is intended to include any piece of software that is provided to implement part of any layer of the communication definition. “Protocol” may include the functionality of one or more of the following layers: physical layer (layer 1), data link layer (layer 2), network layer (layer 3), or any other sub-layer of the mentioned layers or any upper layer.

Various embodiments are provided for devices, and various embodiments are provided for methods. It will be understood that basic properties of the devices also hold for the methods and vice versa. Therefore, for sake of brevity, duplicate description of such properties is omitted.

In various embodiments, MD, e.g. UE, Interacting with neighboring devices via a novel Local Cognitive Pilot Channel (LCPC) will be provided, as will be explained in detail below. Besides, like usually used MD, a MD may always be able to exchange useful data traffic with base stations, access points or neighboring devices.

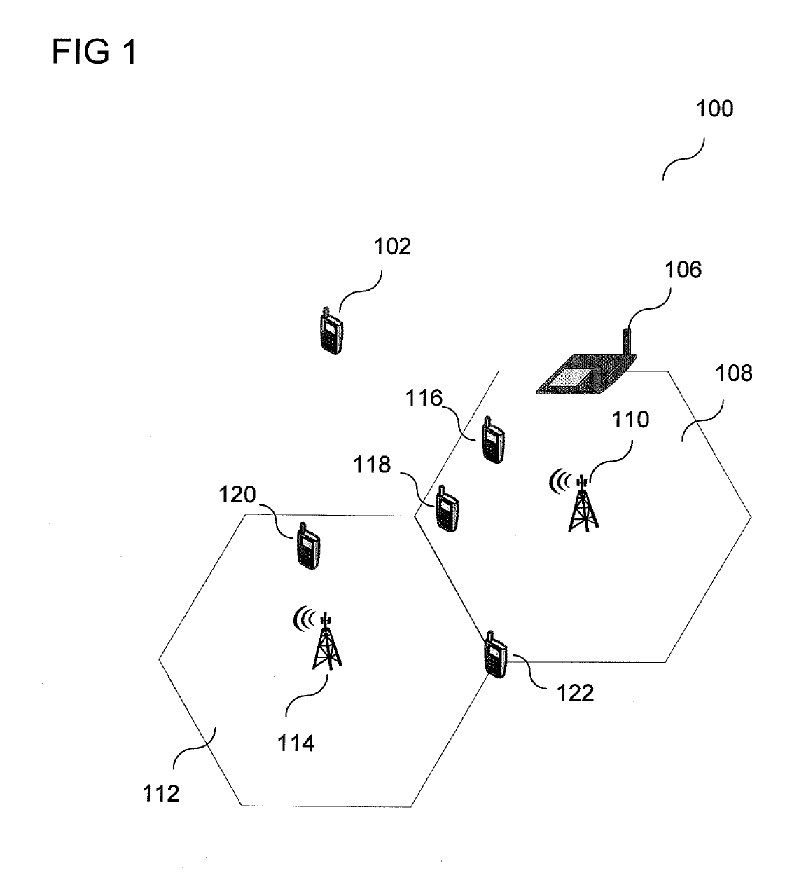

FIG. 1 shows a radio communication system 100 in accordance with an embodiment. An end-user mobile device 102 may be able to send data and receive data in an end-user mobile device coverage area. Furthermore, a wireless access point (AP) 106 may be provided. This wireless access point may be able to send data and receive data in a wireless access point coverage area (not shown). A first base station 110 and a second base station 114 may be provided. The first base station 110 and the second base station 114 may be configured according to any commonly used mobile radio communication standard. The first base station 110 may provide a first base station coverage area 108, and the second base station 114 may provide a second base station coverage area 112. The first base station 110 may be able to communicate with end-user mobile devices located in the first base station coverage area 108, e.g. with the end-user mobile devices 116, 118 and 122. The second base station 120 may be able to communicate with end-user mobile devices located in the second base station coverage area 112, e.g. with the end-user mobile devices 120 and 122.

In FIG. 1, the end-user mobile devices 116, 118 and 120 may be located next to the end-user mobile device 102, and thus the end-user mobile devices 116, 118 and 120 will also be referred to as neighboring end-user mobile devices 116, 118 and 120, in relation to the considered end-user mobile device 102.

Although only two base stations 110 and 114 are shown in FIG. 1, any number of base stations may be provided in a radio communication system according to various embodiments. Furthermore, although only one wireless access point 106 is shown in FIG. 1, any number of wireless access points may be provided in a radio communication system according to various embodiments. Although only two different access technologies are shown in FIG. 1, any number of different access technologies may be provided in a radio communication system according to various embodiments. Each of the end-user mobile devices 102, 116, 118, 120 and 122 provides a respective end-user mobile device coverage area.

Cellular communication systems usually may exploit a wireless link between mobile devices MD, e.g. User Equipment (UE, such as end-user mobile devices 102, 116, 118, 120, 122 shown in FIG. 1) and Base-Stations (BS, such as base stations 110 and 114 shown in FIG. 1) in order to exchange information.

According to various embodiments, as will be explained in detail below, a possibility is provided that a MD, e.g. UE, is not directly communicating with a BS, but rather the communication originating from the MD or BS is forwarded by a Relay Node (RN) positioned somewhere between the considered MD and BS. Thus, the receiver may finally receive the forwarded signal from the RN. According to various embodiments, such an RN can either be a fixed RN (typically deployed by a mobile radio communication network operator) or a mobile RN (for example, other MDs, e.g. other UEs, can act as RNs). According to various embodiments, a MD may choose to communicate rather via a neighboring non-cellular system, such as WLAN (e.g. via AP 106 shown in FIG. 1) or similar, if the respective communication conditions are more favorable (e.g., less connection cost in terms of money to be paid, higher data-rate, less energy consumption, etc.). Relaying in the case of using an AP may be applied analogously to the case of using a BS.

According to various embodiments, the various MDs may have partial knowledge about the context (for example radio context information), for example by scanning the presence of neighboring devices, etc. However, a MD may desire detailed knowledge about the capabilities of neighboring MDs (and other nodes in the network, such as fixed RNs, etc.) in order to trigger a (multi-)hop communication via neighboring MDs to a distant BS, etc. Such information may be called “context information” or “context knowledge”. This is illustrated in more detail below.

According to various embodiments, a MD, e.g. an UE, may obtain context knowledge without scanning all radio communication system of interest (which would be time and power consuming), for example by exchanging context information with neighboring MDs.

According to various embodiments, context information about multi-hop communication may be exchanged.

According to various embodiments, this context information may be used in order to select the most suitable link and the most suitable Radio Access Technology (RAT) to be used by a given MD.

According to various embodiments, devices and methods are provided to trigger context information exchange between MDs in close vicinity pertaining to their respective characteristics, such as radio access technologies being supported or expected battery life time. This may either be done on peer-to-peer basis or via broadcast transmissions by neighboring MDs.

According to various embodiments, an LCPC (Local Cognitive Pilot Channel), as will be explained in more detail below, will be introduced for MDs that may allow them to broadcast the request for context information from neighboring MDs and other devices. The LCPC may be defined by communication resources made available for it (e.g. a dedicated physical channel, a logical channel, etc.) and the possibility to convey broadcast request and context information data.

In various embodiments, an LCPC (Local Cognitive Pilot Channel) may be introduced for MDs that may allow them to broadcast context information (such as link/QoS parameters, multi-hop/relay related parameters, etc.). The broadcast of this context information may be preceded by a request issued by a neighboring MD. In various embodiments, the broadcast of this context information may be performed without any trigger like a request. In various embodiments, the broadcast of this context information may be performed cyclically, for example on a pre-determined time base. Furthermore, in case the broadcast is requested, the request may come from just one MD, but the broadcasted context information may be available to all MDs that are able to receive the signal.

In various embodiments, a concept of ‘neighborhood grade’ may be introduced as will be explained in more detail below. Context information from a direct neighbor may be 1st grade context information, information from the neighbor of a neighbor may be 2nd grade context information, etc. The source MD may indicate the maximum neighborhood grade for the context information it requests. The target MD may then only broadcast context information it obtains from its neighbors up to the maximum neighborhood grade.

According to various embodiments, an LCPC ‘Context Request’ ID may be assigned to each context information provision request. This may allow the management of multi-hop context information provision.

According to various embodiments, MDs, e.g. UEs, may be able to acquire context information and to identify relay nodes at low cost in terms of latency, power consumption, etc.

According to various embodiments, MDs may be able to trigger neighboring MDs to broadcast context information without having knowledge about their presence, parameters, etc.

According to various embodiments, multi-hop context provision may be efficiently handled (i.e. context information may not only originating from direct neighbors, but also from neighbors of neighbors, etc.).

According to various embodiments, un-reliable multi-hop links may be avoided. A MD may know the reliability of a multi-hop link, as this information may be part of the context information. This may be useful as it may be likely that many multi-hop links may be established via MDs acting as relay node and thus may be offering very un-reliable operational service in case they are moving.

According to various embodiments, a MD may desire to acquire context information about the neighboring MDs in order to trigger a multi-hop communication to the BS.

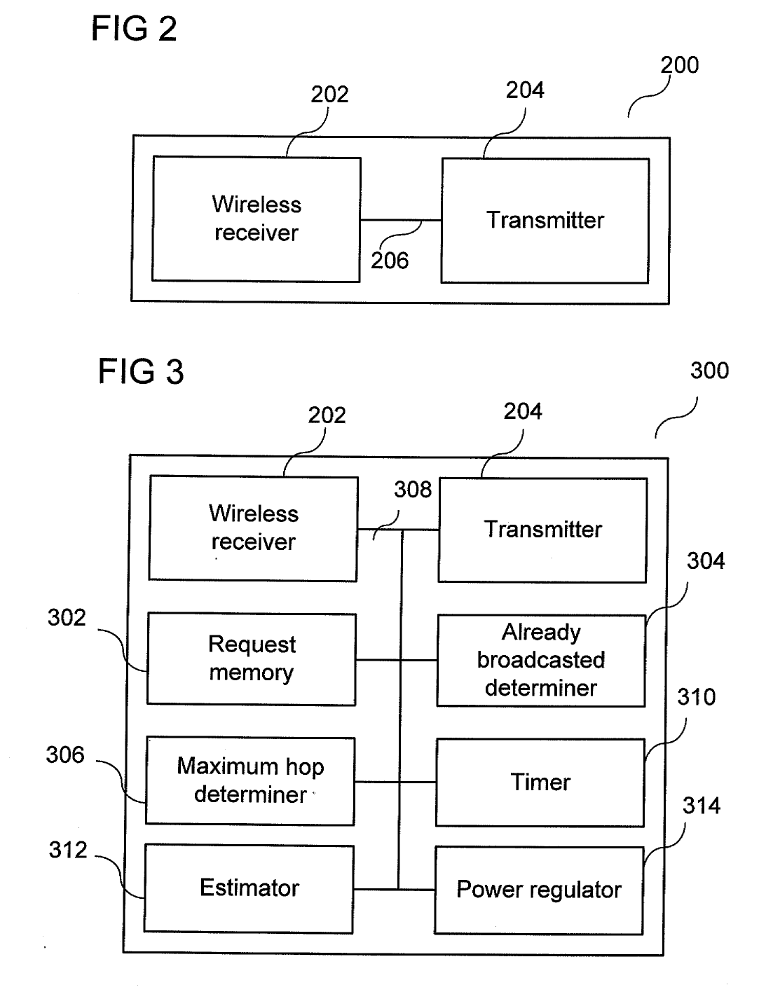

FIG. 2 shows an end-user mobile device 200 in accordance with an embodiment.

The end-user mobile device 200 may include a transmitter 204 configured to broadcast context information based on the occurrence of a pre-determined event. In various embodiments, the end-user mobile device may further include a wireless receiver 202 configured to wirelessly receive a request to request the end-user mobile device to broadcast the context information, wherein the pre-determined event may be the reception of the request to request the end-user mobile device to broadcast context information. In various embodiments, the wireless receiver 202 may be configured to receive a request from a neighboring end-user mobile device. The wireless receiver 202 and the transmitter 204 may be coupled with each other, e.g. via an electrical connection 206 such as e.g. a cable or a computer bus or via any other suitable electrical connection to exchange electrical signals.

In various embodiments, the end-user mobile device may further include a timer configured to time a pre-determined time, wherein the pre-determined event is the expiration of the timer.

In various embodiments, context information may consist of business context information, radio context information or any other kind of context information that may be collected, evaluated or distributed by the mobile devices.

In various embodiments, a relay node grade may be introduced. The relay node grade may give an indication of the link reliability. For example, three different relay node grades may be considered:

“Fixed” (for relay stations whose position cannot change, which may be mounted nodes provided by operators),

“Quasi-Static” (MDs, e.g. UEs, which may be acting as relays, which may have not changed their position within a given time-frame, for example several seconds or minutes),

“Mobile” (MDs, e.g. UEs, which may be acting as Relays and which change their position quite frequently or are even in constant movement).

According to various embodiments, a finer granularity of relay node grade with more than three grades may be provided, e.g. distinguishing the speed or frequency a MD is changing its location.

In various embodiments, the end-user mobile device 200 may be configured as at least one of the following devices: a mobile telephone, a personal digital assistant, a handheld computer, and a femto cell base station.

In various embodiment, the wireless receiver 202 may be configured according to at least one radio communication technology of one of the following radio communication technology families:

a Short Range radio communication technology family;

a Metropolitan Area System radio communication technology family;

a Cellular Wide Area radio communication technology family;

a radio communication technology family which includes a radio communication technology in which the access to radio resources is provided in a random manner; and

a radio communication technology family which includes a radio communication technology in which the access to radio resources is provided in a centrally controlled manner.

In various embodiments, the wireless receiver 202 may be configured to provide mobile radio function according to at least one of the following radio communication technologies: a Bluetooth radio communication technology, an Ultra Wide Band (UWB) radio communication technology, a Wireless Local Area Network radio communication technology (e.g. according to an IEEE 802.11 (e.g. IEEE 802.11n) radio communication standard)), IrDA (Infrared Data Association), Z-Wave and ZigBee, HiperLAN/2 ((High PErformance Radio LAN; an alternative ATM-like 5 GHz standardized technology), IEEE 802.11a (5 GHz), IEEE 802.11g (2.4 GHz), IEEE 802.11n, IEEE 802.11VHT (VHT=Very High Throughput), e.g. IEEE 802.11ac for VHT below 6 GHz and IEEE 802.11ad for VHT at 60 GHz, a Worldwide Interoperability for Microwave Access (WiMax) (e.g. according to an IEEE 802.16 radio communication standard, e.g. WiMax fixed or WiMax mobile), WiPro, HiperMAN (High Performance Radio Metropolitan Area Network), IEEE 802.16m Advanced Air Interface, a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology (e.g. UMTS (Universal Mobile Telecommunications System), FOMA (Freedom of Multimedia Access), 3GPP LTE (long term Evolution), 3GPP LTE Advanced (long term Evolution Advanced)), CDMA2000 (Code division multiple access 2000), CDPD (Cellular Digital Packet Data), Mobitex, 3G (Third Generation), CSD (Circuit Switched Data), HSCSD (High-Speed Circuit-Switched Data), UMTS (3G) (Universal Mobile Telecommunications System (Third Generation)), W-CDMA (UMTS) (Wideband Code Division Multiple Access (Universal Mobile Telecommunications System)), HSPA (High Speed Packet Access), HSDPA (High-Speed Downlink Packet Access), HSUPA (High-Speed Uplink Packet Access), HSPA+(High Speed Packet Access Plus), UMTS-TDD (Universal Mobile Telecommunications System-Time-Division Duplex), TD-CDMA (Time Division-Code Division Multiple Access), TD-CDMA (Time Division-Synchronous Code Division Multiple Access), 3GPP Rel. 8 (Pre-4G) (3rd Generation Partnership Project Release 8 (Pre-4th Generation)), UTRA (UMTS Terrestrial Radio Access), E-UTRA (Evolved UMTS Terrestrial Radio Access), LTE Advanced (4G) (long term Evolution Advanced (4th Generation)), cdmaOne (2G), CDMA2000 (3G) (Code division multiple access 2000 (Third generation)), EV-DO (Evolution-Data Optimized or Evolution-Data Only), AMPS (1G) (Advanced Mobile Phone System (1st Generation)), TACS/ETACS (Total Access Communication System/Extended Total Access Communication System), D-AMPS (2G) (Digital AMPS (2nd Generation)), PTT (Push-to-talk), MTS (Mobile Telephone System), IMTS (Improved Mobile Telephone System), AMTS (Advanced Mobile Telephone System), OLT (Norwegian for Offentlig Landmobil Telefoni, Public Land Mobile Telephony), MTD (Swedish abbreviation for Mobiltelefonisystem D, or Mobile telephony system D), Autotel/PALM (Public Automated Land Mobile), ARP (Finnish for Autoradiopuhelin, “car radio phone”), NMT (Nordic Mobile Telephony), Hicap (High capacity version of NTT (Nippon Telegraph and Telephone)), CDPD (Cellular Digital Packet Data), Mobitex, DataTAC, iDEN (Integrated Digital Enhanced Network), PDC (Personal Digital Cellular), CSD (Circuit Switched Data), PHS (Personal Handy-phone System), WiDEN (Wideband Integrated Digital Enhanced Network), iBurst, and Unlicensed Mobile Access (UMA, also referred to as also referred to as 3GPP Generic Access Network, or GAN standard)).

In various embodiments, the transmitter 204 may be configured according to at least one radio communication technology of one of the radio communication technology families similar to those of the wireless receiver 202 described above.

In various embodiments, the transmitter 204 may be configured to provide mobile radio function according to at least one of the radio communication technologies similar to those of the wireless receiver 202 described above.

In various embodiments, the wireless receiver 202 may be configured to receive data on a dedicated channel. For example, a channel that may only be used for transmitting data according to various embodiments, but that may not be used for any other data transmission, may be used for data reception of the wireless receiver 202 in accordance with various embodiments.

In various embodiments, the wireless receiver 202 may be configured to receive data as payload on a commonly used channel. For example, a channel that may also be used for other purposes than for transmitting data according to various embodiments may be used for data reception of the wireless receiver 202 in accordance with various embodiments.

In various embodiments, the transmitter 204 may be configured to receive data on a dedicated channel. For example, a channel that may only be used for transmitting data according to various embodiments, but that may not be used for any other data transmission, may be used for data transmission of the transmitter 204 in accordance with various embodiments.

In various embodiments, the transmitter 204 may be configured to receive data as payload on a commonly used channel. For example, a channel that may also be used for other purposes than for transmitting data according to various embodiments may be used for data transmission of the transmitter 204 in accordance with various embodiments.

FIG. 3 shows an end-user mobile device 300 in accordance with an embodiment.

The end-user mobile device 300 may include, like the end-user mobile device 200 of FIG. 2, a wireless receiver 202 configured to wirelessly receive a request to request the end-user mobile device to broadcast context information and a transmitter 204 configured to broadcast the context information. The end-user mobile device 300 may further include a request memory 302 configured to store information identifying the request; an already-broadcasted determiner 304 configured to determine whether requested context information has been broadcasted in the past based on the content of the request memory 302; a maximum hop determiner 306 configured to determine whether the hop number, as will be explained below, is below a hop number threshold, a timer 310 configured to time a pre-determined time, an estimator 312 configured to estimate the number of other mobile devices in the vicinity of the end-user mobile device, and a power regulator 314 configured to regulate the transmission power, with which the context information is broadcasted, based on the estimated number of other mobile devices in the vicinity of the end-user mobile device.. The wireless receiver 202, the transmitter 204, the request memory 302, the already broadcasted determiner 304, the maximum hop determiner 306, the timer 310, the estimator 312 and the power regulator 314 may be coupled with each other, e.g. via an electrical connection 308 such as e.g. a cable or a computer bus or via any other suitable electrical connection to exchange electrical signals.

In various embodiments, the request memory 302 may be further configured to store the sender of a request in association with the information identifying the request. In various embodiments, the request memory 302 may be further configured to store the reception time of a request in association with the information identifying the request. Thus, it may be possible to determine whether a request has already been received and thus it may be possible to avoid broadcasting the same context information more than one time, or more than one time in a pre-determined period of time.

In various embodiments, the broadcasted context information may include business context information, radio context information or any other kind of context information that may be collected, evaluated or distributed by the mobile devices.

In various embodiments, the broadcasted context information may include physical context information.

In various embodiments, the broadcasted context information may include a location of the end-user mobile device.

In various embodiments, the end-user mobile device 300 may further include a location determiner configured to determine a location of the end-user mobile device. The location determiner may be a Global Positioning System (GPS) receiver provided in the end-user mobile device 300. The location determiner may be a location determiner that determines the location based on received signals from various base stations and may compute the location based on triangulation methods.

In various embodiments, the broadcasted context information may include a distance of the end-user mobile device 300 to a base station serving the end-user mobile device 300.

In various embodiments, the end-user mobile device 300 may further include a base station distance determiner configured to determine a distance of the end-user mobile device 300 to a base station serving the end-user mobile device.

In various embodiments, the broadcasted context information may include information identifying a radio access technology available at the location of the end-user mobile device 300.

In various embodiments, the end-user mobile device 300 may further include an availability determiner configured to determine a radio access technology available at the location of the end-user mobile device 300.

In various embodiments, the broadcasted context information may include information indicating a signal quality of a radio access technology available at the location of the end-user mobile device 300.

In various embodiments, the end-user mobile device 300 may further include a quality determiner configured to determine a signal quality of a radio access technology available at the location of the end-user mobile device 300.

In various embodiments, the broadcasted context information may include information indicating an available transmission capacity of a radio access technology available at the location of the end-user mobile device 300.

In various embodiments, the end-user mobile device 300 may further include a capacity determiner configured to determine an available transmission capacity of a radio access technology available at the location of the end-user mobile device 300.

In various embodiments, the broadcasted context information may include information indicating a prognosis for at least one of a signal quality and an available transmission capacity of a radio access technology available at the location of the end-user mobile device 300.

In various embodiments, the end-user mobile device 300 may further include a prognosis determiner configured to determine a prognosis for at least one of a signal quality and an available transmission capacity of a radio access technology available at the location of the end-user mobile device 300.

In various embodiments, the granularity of the context information may depend on the density of end-user mobile devices in the vicinity of the end-user mobile device 300.

In various embodiments, the broadcasted context information may include business context information.

In various embodiments, the broadcasted context information may include advertisement information.

In various embodiments, the broadcasted context information may include at least a part of the request received by the wireless receiver.

In various embodiments, the request may include a hop number indicating the number of hops the request has been relayed from its originator.

In various embodiments, the broadcasted context information may include the hop number increased by one.

In various embodiments, the transmitter 204 may be configured to broadcast the context information only if the maximum hop determiner 306 determines that the hop number is below a hop number threshold. This may allow context information to be relayed only up to a maximum hop number. This may be of specific use for cases, where it is assumed that use of context information decreases with the distance of its origin.

In various embodiments, the request may include a base station hop number indicating the number of hops the request has been relayed from an end-user mobile device in direct connection to a base station.

In various embodiments, the broadcasted context information may include the base station hop number increased by one. This may allow an end-user mobile device receiving broadcasted context information from another end-user mobile device to judge how many hops would be required to establish a relayed connection to a base station via the end-user mobile device that broadcasted this context information.

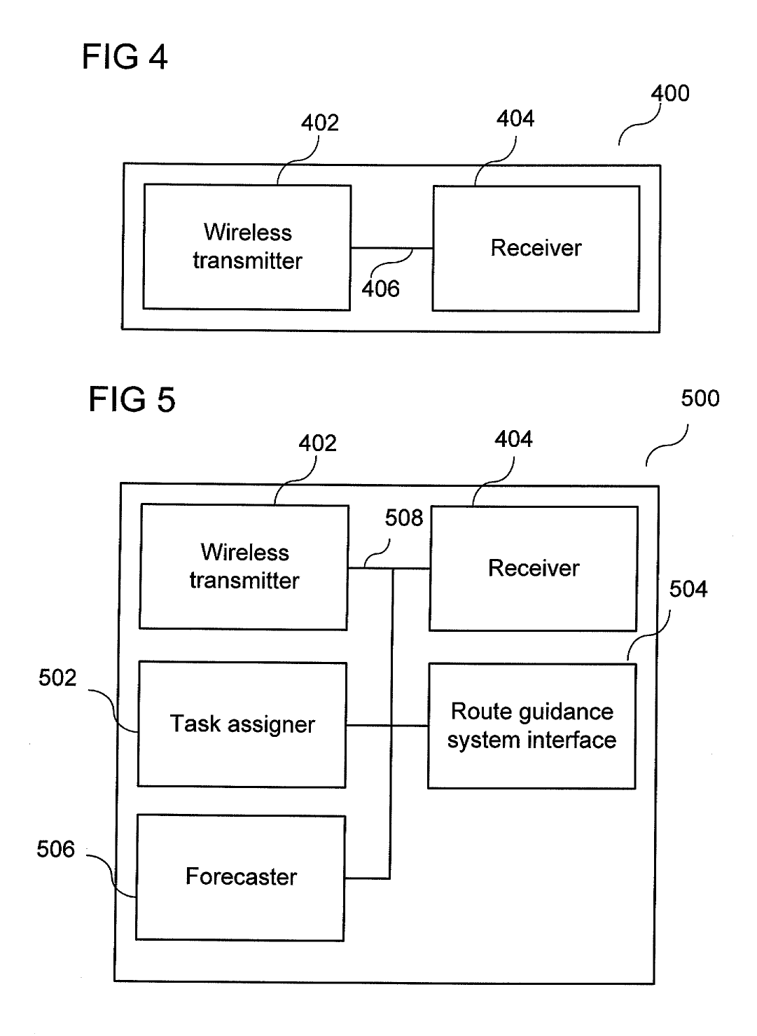

FIG. 4 shows an end-user mobile device 400 in accordance with an embodiment.

The end-user mobile device 400 may include a wireless transmitter 402 configured to wirelessly transmit a request to request an other end-user mobile device to broadcast context information and a receiver 404 configured to receive the broadcast context information. The wireless transmitter 402 and the receiver 404 may be coupled with each other, e.g. via an electrical connection 406 such as e.g. a cable or a computer bus or via any other suitable electrical connection to exchange electrical signals.

In various embodiments, the wireless transmitter 402 may be configured according to at least one radio communication technology of one of the radio communication technology families similar to those of the transmitter 204 described with reference to FIG. 2.

In various embodiments, the wireless transmitter 402 may be configured to provide mobile radio function according to at least one of the radio communication technologies similar to those of the transmitter 204 described with reference to FIG. 2.

In various embodiments, the receiver 404 may be configured according to at least one radio communication technology of one of the radio communication technology families similar to those of the wireless receiver 202 described with reference to FIG. 2.

In various embodiments, the receiver 404 may be configured to provide mobile radio function according to at least one of the radio communication technologies similar to those of the wireless receiver 202 described with reference to FIG. 2.

FIG. 5 shows an end-user mobile device 500 in accordance with an embodiment.

The end-user mobile device 500 may include, like the end-user mobile device 400 of FIG. 4, a wireless transmitter 402 configured to wirelessly transmit a request to request an other end-user mobile device to broadcast context information and a receiver 404 configured to receive the broadcast context information. The end-user mobile device 500 may further include a task assigner 502 configured to assign a task out of a plurality of tasks to the other end-user mobile device, a route guidance system interface 504 configured to acquire route information of the end-user mobile device 500 from a route guidance system and a forecaster 506 configured to forecast operating conditions at the end-user mobile device 500 based on the received broadcast context information and the acquired route information. The wireless transmitter 402, the receiver 404, the task assigner 502, the route guidance system interface 504 and the forecaster 506 may be coupled with each other, e.g. via an electrical connection 508 such as e.g. a cable or a computer bus or via any other suitable electrical connection to exchange electrical signals.

In various embodiments, the request may include information identifying the task.

In various embodiments, the task assigner 502 may be further configured to assign each task out of the plurality of tasks to a different end-user mobile device. In various embodiments, the wireless transmitter may be further configured to wirelessly transmit a request to request comprising information identifying the respective task to each different end-user mobile device.

Thus, it may be possible to split up an overall task (e.g. the task of scanning for information on all bands) into a plurality of smaller tasks (e.g. the tasks of scanning only a limited range of bands, respectively), and assign the different tasks to different end-user mobile devices.

In order to discover context information, MDs may need to scan the environment. However, this process may be extremely costly in terms of latency and power consumption. A typical scan process may cover a frequency range of 500 MHz to 6 GHz and may last several minutes.

The wireless transmitter of an end-user mobile device, that may be chosen as a task manager (which may be considered as a cluster head of a cluster of end-user mobile devices performing the respective tasks), may transmit the information to the respective end-user mobile devices, and each of the end-user mobile device may perform the task (e.g. scan a limited range of bands, respectively) and may broadcast the result (e.g. information on availability of information providing devices like base stations or access points on the respective limited band). Thus, not only the task manager, but also all other end-user mobile devices may gather information about the complete spectrum of bands, and each of the end-user mobile device may have to scan only a limited band itself.

In various embodiments, an end-user mobile device may include a task determiner configured to determine a task to be executed based on the received broadcast context information.

In various embodiments, an end-user mobile device may include another forecaster configured to forecast operating conditions at the end-user mobile device based on the received broadcast context information.

In various embodiments, the route guidance system to which the route guidance system interface 504 provides an interface may be a satellite navigation system.

By taking into account route information acquired by the route guidance system interface 504, the forecaster 506 may forecast data along the route the end-user mobile device 500 will probably move, e.g. may forecast when to perform a handover, because another base station may be available at a certain point of the predicted route.

In various embodiments, the end-user mobile device 500 may further include a broadcast context information filtering system configured to filter the received broadcast context information based on a pre-determined rule.

In various embodiments, the pre-determined rule may be a rule of incorporating information priority levels. For example, the end-user mobile device 500 may consider to only evaluate either broadcasted context information that was broadcasted upon its own request, or high priority context information that was broadcasted upon request of other end-user mobile devices.

In various embodiments, the end-user mobile device 500 may consider to only evaluate broadcasted context information related to locations along a route acquired by the route guidance system interface 504.

It is to be noted that features and properties explained with reference to any one of the end-user mobile device 200 of FIG. 2, the end-user mobile device 300 of FIG. 3, the end-user mobile device 400 of FIG. 4 and the end-user mobile device 500 of FIG. 5 may also be applied to the other end-user mobile devices, e.g. features and properties explained with particular relevance to the end-user mobile device 300 of FIG. 3 may be also applied to the end-user mobile device 500 of FIG. 5, and vice versa.

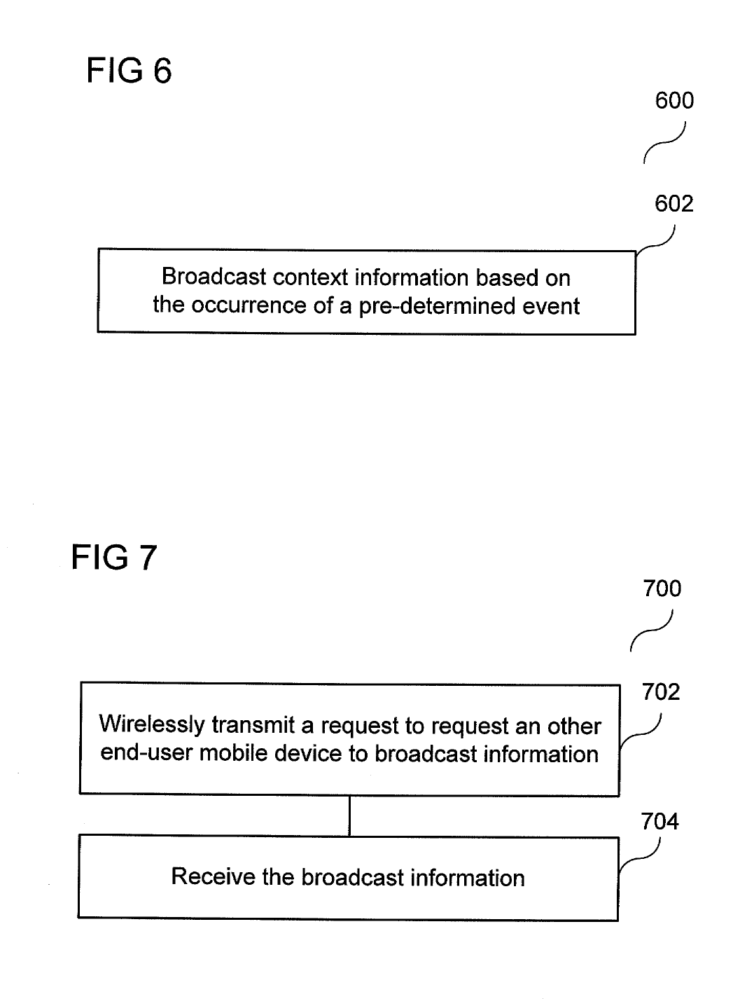

FIG. 6 shows a flow diagram 600 illustrating a method for controlling an end-user mobile device in accordance with an embodiment. In 602, may broadcast context information based on the occurrence of a pre-determined event.

In various embodiments, the end-user mobile device may receive a request to request the end-user mobile device to broadcast the context information, wherein the pre-determined event is the reception of the request to request the end-user mobile device to broadcast context information. In various embodiments, the request may be received from a neighboring end-user mobile device.

In various embodiments, the end-user mobile device may time a pre-determined time, wherein the pre-determined event is the expiration of the pre-determined time.

In various embodiments, the end-user mobile device may estimate the number of other mobile devices in the vicinity of the end-user mobile device, and may regulating the transmission power, with which the context infozi nation is broadcasted, based on the estimated number of other mobile devices in the vicinity of the end-user mobile device.

In various embodiments, the end-user mobile device may be at least one of the following devices: a mobile telephone, a personal digital assistant, a handheld computer; and a femto cell base station.

In various embodiments, the end-user mobile device may receive data in accordance with at least one radio communication technology of one of the following radio communication technology families:

a Short Range radio communication technology family;

a Metropolitan Area System radio communication technology family;

a Cellular Wide Area radio communication technology family;

a radio communication technology family which includes a radio communication technology in which the access to radio resources is provided in a random manner; and

a radio communication technology family which includes a radio communication technology in which the access to radio resources is provided in a centrally controlled manner.

In various embodiments, the end-user mobile device may receive data according to at least one of the following radio communication technologies: a Bluetooth radio communication technology, an Ultra Wide Band (UWB) radio communication technology, a Wireless Local Area Network radio communication technology (e.g. according to an IEEE 802.11 (e.g. IEEE 802.11n) radio communication standard)), IrDA (Infrared Data Association), Z-Wave and ZigBee, HiperLAN/2 ((High PErformance Radio LAN; an alternative ATM-like 5 GHz standardized technology), IEEE 802.11a (5 GHz), IEEE 802.11g (2.4 GHz), IEEE 802.11n, IEEE 802.11 VHT (VHT=Very High Throughput), e.g. IEEE 802.11ac for VHT below 6 GHz and IEEE 802.11ad for VHT at 60 GHz, a Worldwide Interoperability for Microwave Access (WiMax) (e.g. according to an IEEE 802.16 radio communication standard, e.g. WiMax fixed or WiMax mobile), WiPro, HiperMAN (High Performance Radio Metropolitan Area Network), IEEE 802.16m Advanced Air Interface, a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology (e.g. UMTS (Universal Mobile Telecommunications System), FOMA (Freedom of Multimedia Access), 3GPP LTE (long term Evolution), 3GPP LTE Advanced (long term Evolution Advanced)), CDMA2000 (Code division multiple access 2000), CDPD (Cellular Digital Packet Data), Mobitex, 3G (Third Generation), CSD (Circuit Switched Data), HSCSD (High-Speed Circuit-Switched Data), UMTS (3G) (Universal Mobile Telecommunications System (Third Generation)), W-CDMA (UMTS) (Wideband Code Division Multiple Access (Universal Mobile Telecommunications System)), HSPA (High Speed Packet Access), HSDPA (High-Speed Downlink Packet Access), HSUPA (High-Speed Uplink Packet Access), HSPA+(High Speed Packet Access Plus), UMTS-TDD (Universal Mobile Telecommunications System-Time-Division Duplex), TD-CDMA (Time Division-Code Division Multiple Access), TD-CDMA (Time Division-Synchronous Code Division Multiple Access), 3GPP Rel. 8 (Pre-4G) (3rd Generation Partnership Project Release 8 (Pre-4th Generation)), UTRA (UMTS Terrestrial Radio Access), E-UTRA (Evolved UMTS Terrestrial Radio Access), LTE Advanced (4G) (long term Evolution Advanced (4th Generation)), cdmaOne (2G), CDMA2000 (3G) (Code division multiple access 2000 (Third generation)), EV-DO (Evolution-Data Optimized or Evolution-Data Only), AMPS (1G) (Advanced Mobile Phone System (1st Generation)), TACS/ETACS (Total Access Communication System/Extended Total Access Communication System), D-AMPS (2G) (Digital AMPS (2nd Generation)), PTT (Push-to-talk), MTS (Mobile Telephone System), IMTS (Improved Mobile Telephone System), AMTS (Advanced Mobile Telephone System), OLT (Norwegian for Offentlig Landmobil Telefoni, Public Land Mobile Telephony), MTD (Swedish abbreviation for Mobiltelefonisystem D, or Mobile telephony system D), Autotel/PALM (Public Automated Land Mobile), ARP (Finnish for Autoradiopuhelin, “car radio phone”), NMT (Nordic Mobile Telephony), Hicap (High capacity version of NTT (Nippon Telegraph and Telephone)), CDPD (Cellular Digital Packet Data), Mobitex, DataTAC, iDEN (Integrated Digital Enhanced Network), PDC (Personal Digital Cellular), CSD (Circuit Switched Data), PHS (Personal Handy-phone System), WiDEN (Wideband Integrated Digital Enhanced Network), iBurst, and Unlicensed Mobile Access (UMA, also referred to as also referred to as 3GPP Generic Access Network, or GAN standard)).

In various embodiments, the end-user mobile device may transmit data according to at least one radio communication technology of one of the following radio communication technology families:

a Short Range radio communication technology family;

a Metropolitan Area System radio communication technology family;

a Cellular Wide Area radio communication technology family;

a radio communication technology family which includes a radio communication technology in which the access to radio resources is provided in a random manner; and

a radio communication technology family which includes a radio communication technology in which the access to radio resources is provided in a centrally controlled manner.

In various embodiments, the end-user mobile device may transmit data according to at least one of the radio communication technologies mentioned above.

In various embodiments, the end-user mobile device may receive data on a dedicated channel as described above.

In various embodiments, the end-user mobile device may receive data as payload on a commonly used channel as described above.

In various embodiments, the end-user mobile device may transmit data on a dedicated channel as described above.

In various embodiments, the end-user mobile device may transmit data as payload on a commonly used channel as described above.

In various embodiments, the method for controlling an end-user mobile device may further include storing information identifying the request.

In various embodiments, the end-user mobile device may store the sender of a request in association with the information identifying the request.

In various embodiments, the end-user mobile device may store the reception time of a request in association with the information identifying the request.

In various embodiments, the method for controlling an end-user mobile device may further include determining whether requested context information has been broadcasted in the past based on the stored information.

In various embodiments, the broadcasted context information may include business context information, radio context information or any other kind of context information that may be collected, evaluated or distributed by the mobile devices.

In various embodiments, the broadcasted context information may include physical context information.

In various embodiments, the broadcasted context information may include a location of the end-user mobile device.

In various embodiments, the method for controlling an end-user mobile device may further include determining a location of the end-user mobile device.

In various embodiments, the broadcasted context information may include a distance of the end-user mobile device to a base station serving the end-user mobile device.

In various embodiments, the method for controlling an end-user mobile device may further include determining a distance of the end-user mobile device to a base station serving the end-user mobile device.

In various embodiments, the broadcasted context information may include information identifying a radio access technology available at the location of the end-user mobile device.

In various embodiments, the method for controlling an end-user mobile device may further include determining a radio access technology available at the location of the end-user mobile device.

In various embodiments, the broadcasted context information may include information indicating a signal quality of a radio access technology available at the location of the end-user mobile device.

In various embodiments, the method for controlling an end-user mobile device may further include determining a signal quality of a radio access technology available at the location of the end-user mobile device.

In various embodiments, the broadcasted context information may include information indicating an available transmission capacity of a radio access technology available at the location of the end-user mobile device.

In various embodiments, the method for controlling an end-user mobile device may further include determining an available transmission capacity of a radio access technology available at the location of the end-user mobile device.

In various embodiments, the broadcasted context information may include information indicating a prognosis for at least one of a signal quality and an available transmission capacity of a radio access technology available at the location of the end-user mobile device.

In various embodiments, the method for controlling an end-user mobile device may further include determining a prognosis for at least one of a signal quality and an available transmission capacity of a radio access technology available at the location of the end-user mobile device.

In various embodiments, the granularity of the context information may depend on the density of end-user mobile devices in the vicinity of the end-user mobile device.

In various embodiments, the broadcasted context information may include business context information.

In various embodiments, the broadcasted context information may include advertisement information.

In various embodiments, the broadcasted context information may include at least a part of the request received by the wireless receiver.

In various embodiments, the request may include a hop number indicating the number of hops the request has been relayed from its originator.

In various embodiments, the broadcasted context information may include the hop number increased by one.

In various embodiments, the method for controlling an end-user mobile device may further include determining whether the hop number is below a hop number threshold and broadcasting the context information only if it is determined that the hop number is below a hop number threshold.

In various embodiments, the request may include a base station hop number indicating the number of hops the request has been relayed from an end-user mobile device in direct connection to a base station.

In various embodiments, the broadcasted context information may include the base station hop number increased by one.

FIG. 7 shows a flow diagram 700 illustrating a method for controlling an end-user mobile device in accordance with an embodiment. In 702, the end-user mobile device may wirelessly transmit a request to request an other end-user mobile device to broadcast context information. In 704, the end-user mobile device may receive the broadcast context information.

In various embodiments, the method for controlling an end-user mobile device may further include assigning a task out of a plurality of tasks to the other end-user mobile device. In various embodiments, the request may include information identifying the task.

In various embodiments, the method for controlling an end-user mobile device may further include assigning each task out of the plurality of tasks to a different end-user mobile device. In various embodiments, the method for controlling an end-user mobile device may further include transmitting a request wirelessly to request comprising information identifying the respective task to each different end-user mobile device

In various embodiments, the method for controlling an end-user mobile device may further include determining a task to be executed based on the received broadcast context information.

In various embodiments, the method for controlling an end-user mobile device may further include forecasting operating conditions at the end-user mobile device based on the received broadcast context information.

In various embodiments, the method for controlling an end-user mobile device may further include acquiring route information of the end-user mobile device from a route guidance system.

In various embodiments, the route guidance system may be a satellite navigation system.

In various embodiments, the method for controlling an end-user mobile device may further include forecasting operating conditions at the end-user mobile device based on the received broadcast context information and the acquired route information.

In various embodiments, the method for controlling an end-user mobile device may further include filtering the received broadcast context information based on a pre-determined rule.

In various embodiments, the pre-determined rule may be a rule of incorporating information priority levels.

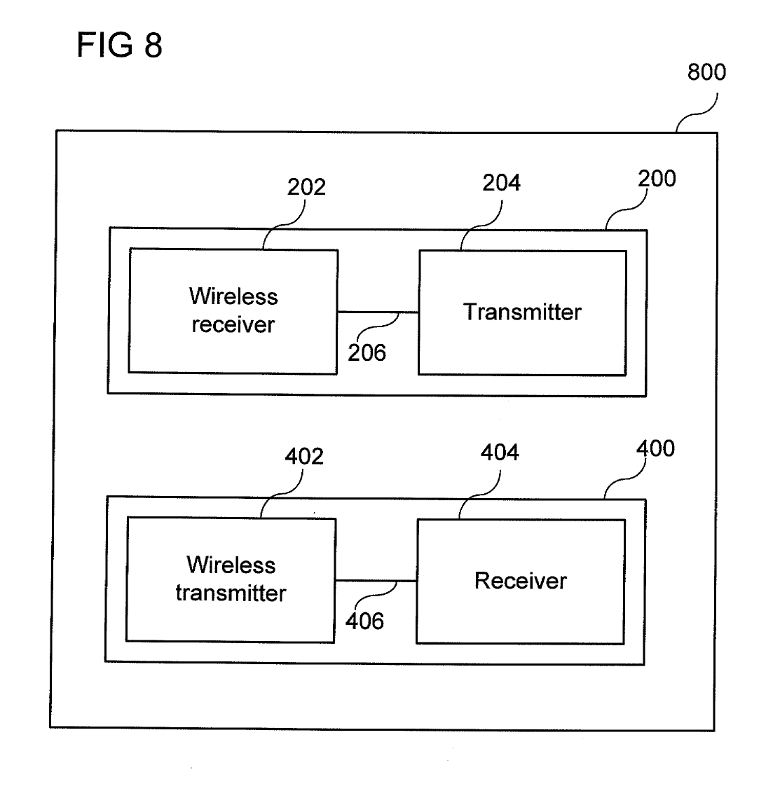

FIG. 8 shows a communication system 800 in accordance with an embodiment. The communication system 800 may include a first end-user mobile device 200 and a second end-user mobile device 400. The first end-user mobile device 200 may include a wireless receiver 202 configured to wirelessly receive a request to request the end-user mobile device to broadcast context information and a transmitter 204 configured to broadcast the context information. The wireless receiver 202 and the transmitter 204 may be coupled with each other, e.g. via an electrical connection 206 such as e.g. a cable or a computer bus or via any other suitable electrical connection to exchange electrical signals. The second end-user mobile device 400 may include a wireless transmitter 402 configured to wirelessly transmit a request to request an other end-user mobile device to broadcast context information and a receiver 400 configured to receive the broadcast context information. The wireless transmitter 402 and the receiver 404 may be coupled with each other, e.g. via an electrical connection 406 such as e.g. a cable or a computer bus or via any other suitable electrical connection to exchange electrical signals. Each of the entities of the first end-user mobile device 200 may be similar to the entities of the end-user mobile device 200 of FIG. 2 and each of the entities of the second end-user mobile device 400 may be similar to the entities of the end-user mobile device 400 of FIG. 4, and detailed description thereof therefore is omitted.

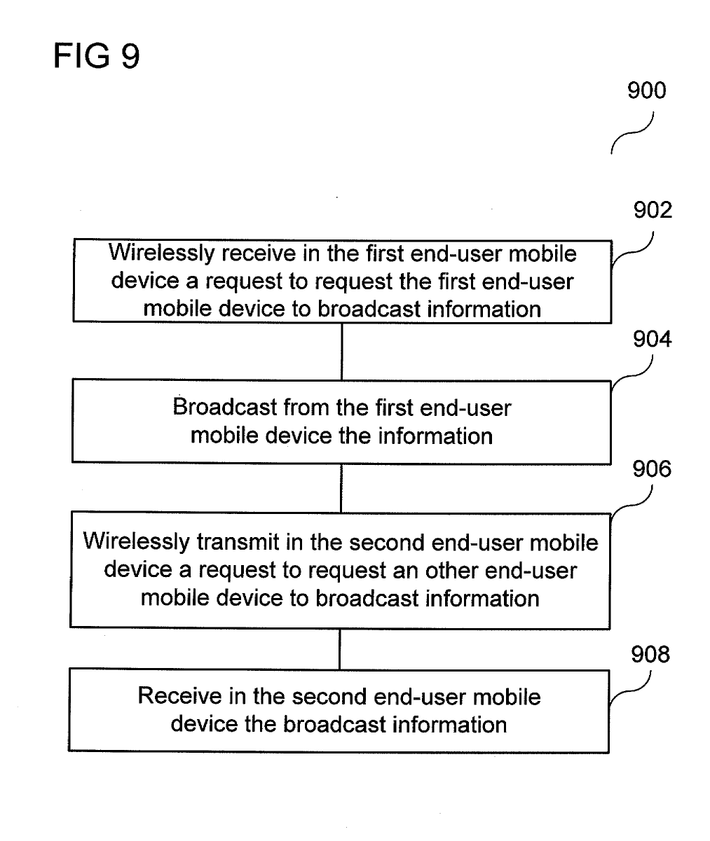

FIG. 9 shows a flow diagram 900 illustrating a method for controlling a communication system including a first end-user mobile device and a second end-user mobile device in accordance with an embodiment. In 902, in the first end-user mobile device a request to request the first end-user mobile device to broadcast context information may be wirelessly received. In 904, the context information may be broadcasted from the first end-user mobile device. In 906, a request to request an other end-user mobile device to broadcast context information may be wirelessly transmitted in the second end-user mobile device. In 908, the broadcast context information may be received in the second end-user mobile device. It is to be noted that in various embodiments, the processes 902, 904, 906, 908 of the method for controlling a communication system may be performed in the following order: first, 906 may be performed; second, 902 may be performed; third, 904 may be performed; fourth, 908 may be performed.

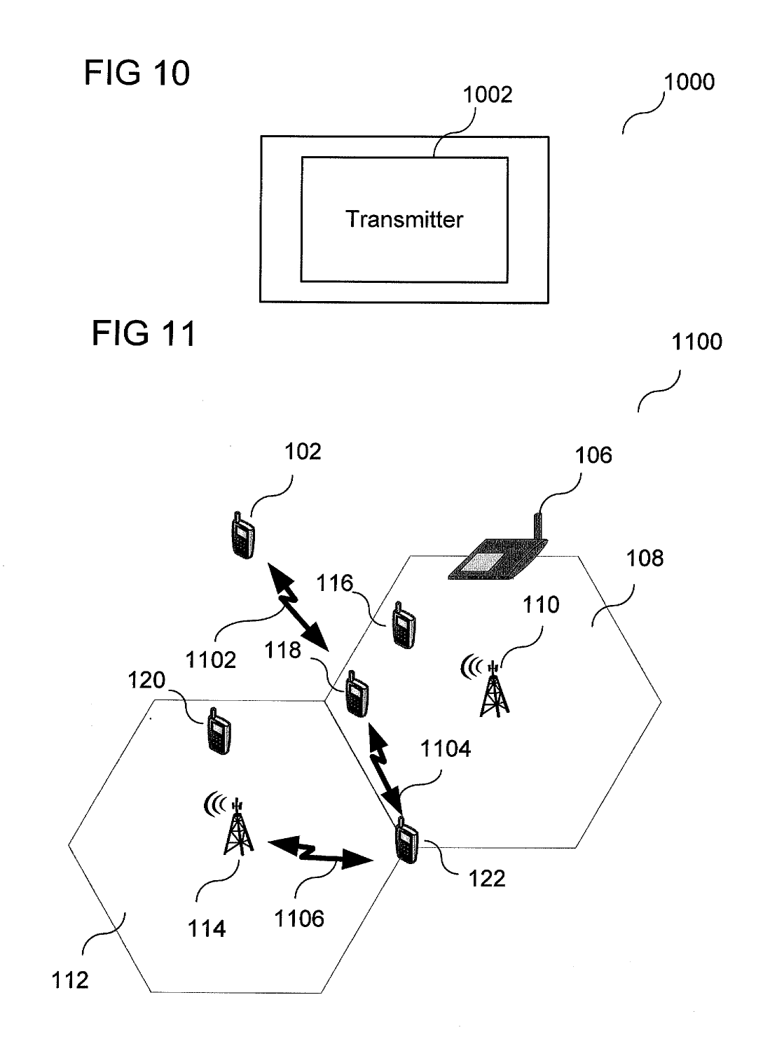

FIG. 10 shows a communication device 1000 in accordance with an embodiment. The communication device 1000 may include a transmitter 1002 configured to broadcast context information based on a wirelessly received request.

In various embodiments, a method for controlling a communication device may be provided. In various embodiments, the method may include broadcasting context information based on a wirelessly received request.

FIG. 11 shows an example of a communication system 1100 where a three-hop communication may be performed in accordance with an embodiment. The basic layout of the radio communication system 1100 is similar to the radio communication system 100 of FIG. 1 and duplicate description of entities provided with the same reference numerals will be omitted.

After having performed information exchange based on requesting context information and broadcasting context information according to various embodiments, the considered end-user mobile device 102 may have decided to communicate via a first relaying end-user mobile device 118 and a second relaying end-user mobile device 122 with the base station 114. The considered end-user mobile device 102 may not be in direct communication with the base station 114, but may be in direct communication with the first relaying end-user mobile device 118, indicated by arrow 1102. The first relaying end-user mobile device 118 may be in direct connection with the second relaying end-user mobile device 122, indicated by arrow 1104. The second relaying end-user mobile device 122 may be in direct connection to the base station 114, indicated by arrow 1106.

The information processing that may have lead to the establishment of the three-hop communication according to an embodiment will now be explained in more detail. Initially, the user of the considered end-user mobile device 102 may perform input operation to the end-user mobile device 102 to request the end-user mobile device 102 to establish connection to a base station. The end-user mobile device 102 may determine that it is not in the coverage area of a base station and thus may determine that it may not establish direct connection to a base station. As a consequence, the end-user mobile device 102 may decide to broadcast a request requesting context information to indicate whether the receiving end-user mobile device is willing to provide services as a relay node for the end-user mobile device 102. After the end-user mobile device 102 has broadcasted the request, the first relaying end-user mobile device 118, which may be configured according to the end-user mobile device 200 of FIG. 2, may receive the request and may determine, that it may not provide direct access to a base station (for example because base station 110, in whose coverage area the first relaying end-user mobile device 118 is, is congested). Then, the first relaying end-user mobile device 118 may broadcast a request for indication of relay nodes, quite similar to the request of the considered end-user mobile device 102. After the first relaying end-user mobile device 118 has broadcasted the request, the second relaying end-user mobile device 122, which may be configured according to the end-user mobile device 200 of FIG. 2, may receive the request, may determine that it may provide direct access and may broadcast context information indicating that it is able and willing to provide services as a relay node. The first relaying end-user mobile device 118, which may also be considered to be configured according to the end-user mobile device 400 of FIG. 4, may receive this broadcasted context information, and may also broadcast this context information to the considered end-user mobile device 102. Upon these notifications, the three-hop relay communication may be established. The notifications of the first relaying end-user mobile device 118 and the second relaying end-user mobile device 122 may also include information on how many hops are necessary for connection to a base station. For example, the second relaying end-user mobile device 122 may include in its notification information indicating a hop count to a base station of ‘1’, indicating that it may connect directly to a base station (for example to the base station 114). The first relaying end-user mobile device 118 that receives this information, may increase the hop count by one, e.g. to ‘2’, indicating that two hops are required for connection to a base station. The considered end-user mobile device 102 will thus know the total number of hops needed for performing connection via the first end-user mobile device 118, e.g. ‘3’.

By broadcasting the information concerning ability and willingness to serve as a relay node by the first relaying end-user mobile device 118 and the second relaying end-user mobile device 122, not only the considered end-user mobile device 102 will be able to acquire this information, but also other end-user mobile devices, that may want to establish a connection at a later time.

In various embodiments, the broadcasted context information may introduce a novel way of providing information. This way of distributing information may be referred to as “Local Cognitive Pilot Channel (LCPC)”. Some of its characteristics will be described in the following:

General Context Information Request (peer-to-peer): Any MD may request the distribution of context information from one or several particular neighboring MDs. Once this request is issued (via the standard connection over the network or via a peer-to-peer link), the target MD, e.g. the target UE, may transmit the requested context information on a so-called “Local Cognitive Pilot Channel (LCPC)”, e.g. as a broadcasted signal. This LCPC may be covering only a small area and may be intended to provide context information to neighboring devices only. This approach may cover localized and/or highly time-variant context information due to the low inherent latency and management overhead.

General Context Information Request (broadcast): Any MD may choose to broadcast the context information requests to all available MDs, also using the LCPC. Then, all neighboring devices receiving this request contained in the LCPC may act as described in the above “General Context Information Request (peer-to-peer)”. With this approach, localized and/or highly time-variant context information may be covered due to the low inherent latency and management overhead. Also, the MD sending the request may not need any knowledge about neighboring MDs—due to the broadcast transmission, a “blind” detection of the presence of neighboring devices and their capabilities may be possible.

Detection of Multi-Hop communication characteristics: By direct detection, a MD may only identify whether it is capable of communicating directly with a BS or via a neighboring MD. According to various embodiments, it may be detected how many hops are required to reach a BS if multi-hop communication via a neighboring MD (or via one or several fixed relay nodes) is used. Depending on the inherent latency and power consumption for a particular radio access technology (which may be very low for a direct MD-to-MD link compared to a MD-to-BS link), the MD may decide on the most suitable configuration. In an embodiment, further MD characteristics, such as estimated remaining battery life time, may also being considered for the selection of a suitable path for multi-hop propagation (for example: “is the target MD capable of serving as a relay node?”). With this approach, multi-hop characteristics may be detected efficiently. The corresponding context information may not only be provided to the MD that triggered the detection/provision of the context information, but may also be available for all neighboring devices.

In the following, an example of how organization of this information request/transmission is performed according to various embodiments will be explained.

An MD, e.g. a UE, may recover context information from neighboring devices by various processes:

1) An MD (“Source MD”) may be requesting the transmission of context information from its neighbors;

2) The “Source MD” may wait for answers of the various Target MDs;

3) The MD may get indications from one or several surrounding “Target MDs” that they are willing to exchange context information and/or serve as relay;

4) The Source MD may select the target MD from which it desires to receive the context information;

5) The Selected Target MD, e.g. a Target UE, may broadcast the Context Information requested by the Source MD in the context information case;

6) The selected “Target MD” may be contacted by further MDs.

Each of the above processes will be explained in more detail below.

In process 1), a MD (“Source MD”), e.g. a UE (“Source UE”), may request the transmission of context information from its neighbors. According to various embodiments, two possible approaches may be provided:

Peer-to-Peer request: The source MD may have knowledge about (some of) the neighboring MDs (and potentially other devices) and may send a peer-to-peer request to one or multiple selected MDs. This peer-to-peer request may either be communicated via the network or by a direct peer-to-peer link between neighboring MDs (e.g. UEs, or other devices).

Broadcast request: The Source MD may sends a (weak) LCPC signal either

i) on a dedicated CPC carrier or

ii) on the standard communication frequency within a slot reserved for CPC application (in the latter case it may be desired that the MD demands the corresponding resources from the BS).

This CPC signal may be supposed to be in “broadcast” mode, i.e. it may be addressing all MDs that are able to decode it (“Target MDs”).

In either case (Peer-to-Peer request or Broadcast request), the sending end-user mobile device (“Source MD”) may be configured according to the end-user mobile device 400 of FIG. 4, and the receiving end-user mobile device (“Target MD”) may be configured according to the end-user mobile device 200 of FIG. 2.

In these requests, the “Source MD” may request information on the “willingness” of surrounding “Target MDs” to cooperate on the following:

A) The source MD may request information indicating an answer to the question “Is the Target MD willing to provide context information?”. In case the answer is “yes” , the relevant type of context information may be broadcasted using resources reserved for the transmission of a LCPC (in a special case, the broadcast of the requested context information may directly start without waiting for any further trigger from the Source MD).

In various embodiments, the broadcasted context information may include information indicating the quality of BS links. This may be of specific user within the same RAT (Radio access technology), where a link that may be suitable for a specific MD may not be suitable for another MD, because of access restrictions or optional MD radio capabilities being supported by the specific MD.

In various embodiments, the broadcasted context information may include available BS/APs (including an indication of the Radio Access Technology, such as 3GPP GSM, 3GPP UMTS, 3GPP LTE, 3GPP LTE-Advanced, WiFi, WiMAX, . . . ).

In various embodiments, the broadcasted context information may include QoS (quality of service) of other (alternative) BS/APs links (e.g., information indicating whether a WiFi is saturated, etc.).

In various embodiments, the broadcasted context information may include information on other MDs (like location, “willingness” to provide context information, to serve as relay, etc.). In various embodiments, the target MD may be providing context information it previously received from its neighboring MDs anti/or other devices. This information may include indications on the source of the information in order to avoid loops such as “A first MD queries a second MD which queries a third MD which queries the first MD, etc.”.

In various embodiments, the broadcasted context information may include information on the location of the Target MD (such that Source MD may do triangulation based on received signals from surrounding MDs).

B) The source MD may request context information indicating an answer to the question “Is the Target MD able to serve as relay?”. In case the answer is yes, constraints such as set forth the following may be indicated.

In various embodiments, the answer may include context information on how many relay links the answering end-user mobile device does already maintain.

In various embodiments, the answer may include information on whether the answering end-user mobile device is moving or fixed. In case it is moving, the answer may include information on the mobility characteristics, which may include information on whether the answering end-user mobile device is approaching the requesting end-user mobile device, just passing by, or leaving, etc. In accordance with various embodiments, several relay-classes may be provided, such as:

“Fixed” (for example for relay stations whose position may not change, for example for relay station that are mounted nodes provided by operators);

“Quasi-Static” (for example for MDs which may be acting as relays, and which have not changed their position within a given time-frame, for example several seconds or minutes); and

“Mobile” (for example for MDs which may be acting as relays, which may change their position frequently or may be even in constant movement).

In various embodiments, the answer may include information on the maximum relay output power.

In various embodiments, the answer may include information on the relay latency.

In various embodiments, the answer may include information on whether all measured and/or predicted terminal characteristics, such as battery life time or processing power allow a Target MD to act as a relay node.

It will be understood that a variety of further context information may be included in the answer.

In various embodiments, each context information provision request may be given a specific ID. This may allow to track the information flow and to manage the context information that is forwarded via multiple hops. An example is given in the following table:

| LCPC ‘Context | | | |
|---|---|---|---|
| Request’ ID | received from | Time Stamp | Note |
| 123456 | MD-A | 0:00:00 | |
| 987654 | MD-B | 0:00:00 | Request with a |
| | | | different ID |
| 123456 | MD-B | 0:00:05 | |
| 123456 | MD-C | 0:00:45 | |
| 123456 | MD-D | 0:01:01 | |

In the example shown in the above table, ‘Context Request’ ID 123456 may have been received by a Target MD four times in total, twice with a large delay. The Target MD may thus return the answer that it may have already provided, in case the requested information is the same and nothing has changed since. Then, the Source MD may determine whether the answers of the late received requests from MD-C and MD-D should really be communicated via MD-C and MD-D; MD-A may obviously be acting faster and may be preferred.

In another embodiment, the data shown in the above table may be used to decide on the forwarding of context information. Another device (for example, MD-E) may receive “context requests” from MD-A to MD-D. Then, it may transmit the context information by regrouping the answers to the suitable requests (in this example, the answers to the first two requests may be regrouped since the requests arrived in the same time; eventually, also the third request may be included because it arrived with only a small delay after the first two requests. The last two requests may probably be dealt with separately and thus new LCPC frames may be transmitted (either by regrouping the last two requests or by transmitting one for each of the requests). Thus, each transmission may contain the information from where the requests came. I.e. if the first transmission of context information answers to the first three requests (from MD-A and MD-B, with MD-B asking twice) are transmitted, the transmitted frame may contain information about i) the LCPC context request ID, ii) where the request was received from (MD-A ID, . . . ), iii) when it was received.

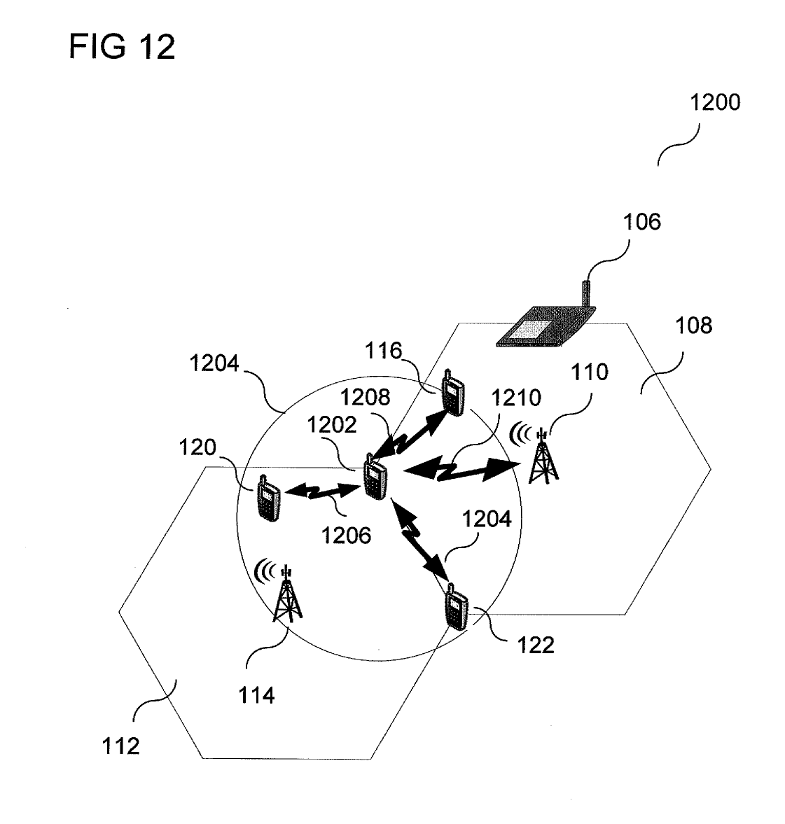

The process of requesting context information by broadcast of a LCPC in accordance with various embodiments will be illustrated with reference to FIG. 12.

FIG. 12 shows a radio communication system 1200 in accordance with an embodiment. The basic layout of the radio communication system 1200 is similar to the radio communication system 100 of FIG. 1 and duplicate description of entities provided with the same reference numerals will be omitted.

In particular, the communication system 1200 shows a “Source MD” 1202 communicating with “Target MDs” 116, 120 and 122 by a LCPC signal 1204, 1206, 1208.

In the radio communication system 1200, the end-user mobile device 1202 may be in direct communication with base station 110 (in other words: in standard communication between an MD and a BS), indicated by arrow 1210. The end-user mobile device 1202 (“source MD”) may be interested in context information of its neighbor end-user mobile stations 116, 120 and 122 (“target MDs”), and therefore may broadcast a request as a local cognitive pilot channel (LCPC) to request transmission of context information, as indicated by arrows 1204, 1206 and 1208.

It will be understood that the source MD 1202 may also broadcast context information of itself to the target MDs 116, 120 and 122 by the Local Cognitive Pilot Channel (LCPC), as indicated by arrows 1204, 1206 and 1208.

The coverage area is indicated by a circle 1204. It will be understood that the coverage area does not have to have the shape of a circle, but according to various environmental conditions may have virtually any shape.

In process 2), the “Source MD” may wait for answers of the various Target MDs.

According to various embodiments, if no answer is received, at least one of various steps may be taken, including the following processes.

As a first process, the LCPC information may be sent again.

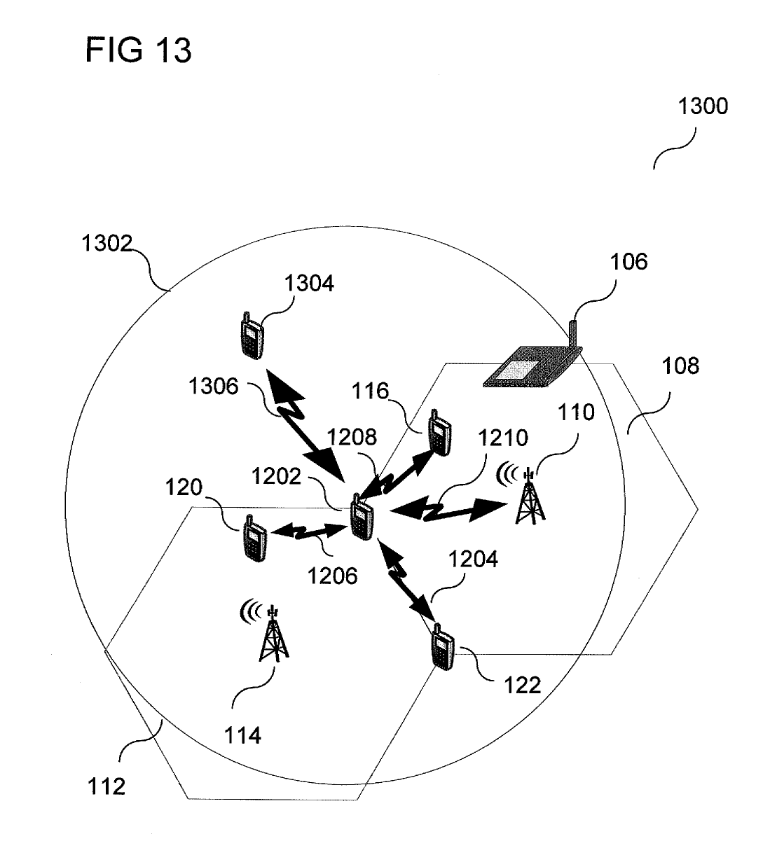

As a second process, output power of LCPC signal may be increased in order to potentially cover more MDs. This principle will be illustrated with reference to FIG. 13.

FIG. 13 shows a radio communication system 1300 in accordance with an embodiment. The basic layout of the radio communication system 1300 is similar to the radio communication system 1200 of FIG. 12 and duplicate description of entities provided with the same reference numerals will be omitted.

Compared to the coverage area 1204 of the LCPC in FIG. 12, the coverage area 1302 of the LCPC is increased in FIG. 13. This may be achieved an increased LCPC output power in order to increase the communication range. Thus, also the end-user mobile device 1304 may be provided with signals of the LCPC, indicated by arrow 1306.

Furthermore, according to various embodiments, a concept of ‘neighborhood grade’ may be introduced: Even when a low-power LCPC is used (reaching only close-by MDs and other devices), a MD may be interested to learn about the capabilities of devices that are out of reach with the given LCPC output power. In this case, neighboring MDs (within the range of the LCPC) may provide context information which they may have received in the past by issuing a context information provision request by a LCPC (2nd grade information). The communication range may be increased by further increased the grade (3rd grade information originates from neighbors of neighbors, etc.). By using the ‘neighborhood grade’ concept, it may be possible to control (enlarge/restrict) the propagation of context queries. A MD, e.g. a UE, may be capable of indicating of which grade its context information is. Furthermore, the Source MD may be able to indicate a maximum information grade. The maximum propagation grade may be increased step by step in order to increase the ‘area’ covered or ‘distance’ to other MDs.

In various embodiments, indication on the ‘multi-hop grade’ may be provided, i.e. the target MD may indicate how many hops (if any) it is using in order to reach the BS.

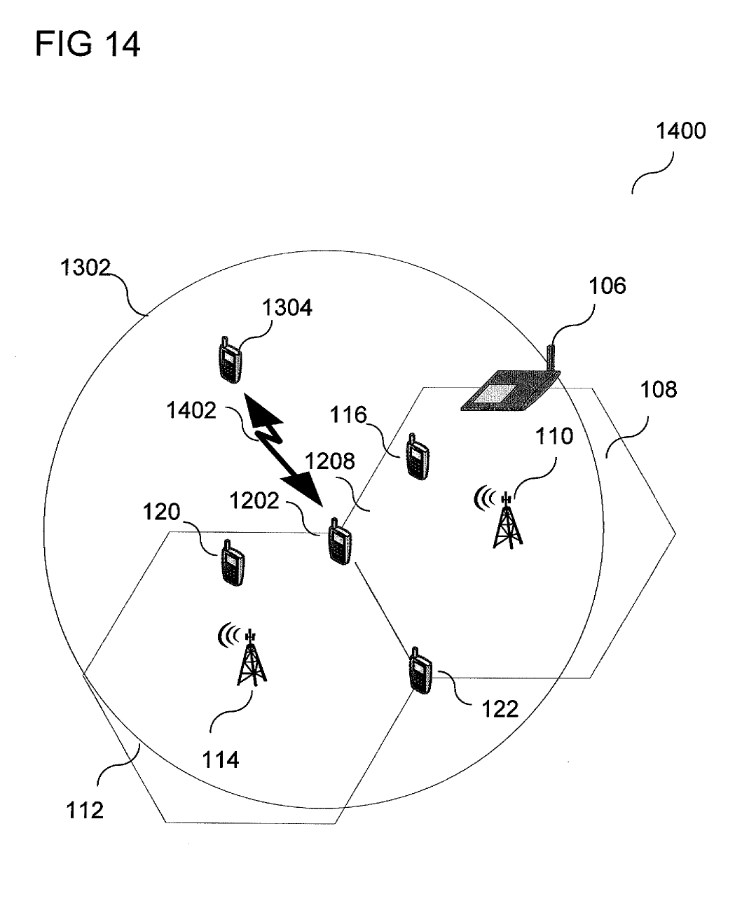

In process 3), the MD may get indications from one or several surrounding “Target MDs” that they are willing to exchange context information and/or serve as relay. This will be illustrated with reference to FIG. 14.

FIG. 14 shows a radio communication system 1400 in accordance with an embodiment. The basic layout of the radio communication system 1400 is similar to the radio communication system 1300 of FIG. 13 and duplicate description of entities provided with the same reference numerals will be omitted.

After having received the LCPC signal, the target end-user mobile device 1304 may send an indication of “willingness” to provide information, e.g. context information, and/ or to serve as a relay link. Sending this information is indicated by arrow 1402 in FIG. 14.

In process 4), the Source MD may select the target MD from which it wants to receive the information. The source MD may contact the target MD again and may request the transmission of the context information and/or may confirm that it will be used as relay node. When it becomes a relay node, the ‘multi-hop grade’ may be incremented by ‘1’.

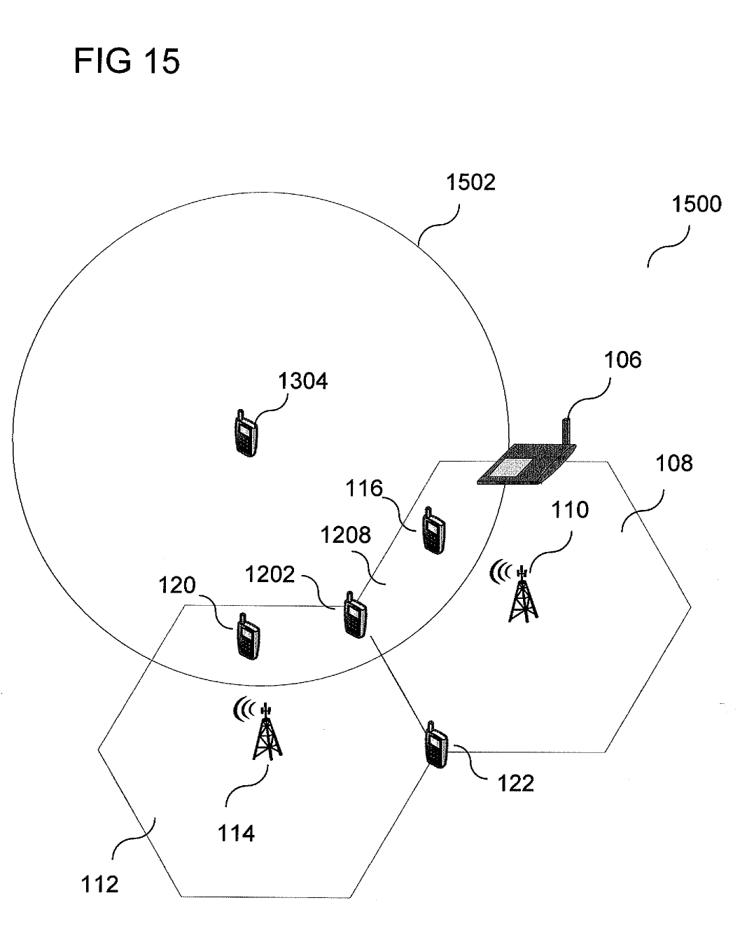

In process 5), the selected target MD may broadcast the context information requested by the source MD in the context information case. This will be illustrated with reference to FIG. 15.

FIG. 15 shows a radio communication system 1500 in accordance with an embodiment. The basic layout of the radio communication system 1500 is similar to the radio communication system 1400 of FIG. 14 and duplicate description of entities provided with the same reference numerals will be omitted.

After the target MD has been chosen, the selected target MD, which is assumed to be the MD 1304 in FIG. 15, may provide context information in broadcast mode which can be received by any MD 116, 120, 1202 in the communication range 1502.

In process 6), the selected “Target MD” may be contacted by further MDs. According to various embodiments, the selected “Target MD” may be contacted by further MDs to increase the communication range or to provide further information, etc. In this case, the selected target MD may choose to increase the output power of the broadcast context information signal and/or to add further information.

In the following, another example of the operation of a communication system according to various embodiments will be illustrated.

Various embodiments may be applicable in a standard wireless communication context where a MD may have one or multiple neighboring MDs or other neighboring communication devices. By applying the techniques according to various embodiments, the MD may be able to acquire the most relevant context information, choose (if appropriate) a multi-hop communication configuration and choose the most suitable communication mode. This may be achieved by the following processes:

1) A Source MD may be switched on; it may have no knowledge about the current communication framework;

2) The Source MD may distribute a context information request by a low-power LCPC;

3) In case no answer may be received by the Source MD within a predefined time, step 4) may be executed; otherwise, proceeding may continue with step 5);

4) The Source MD may increase the power of the LCPC transmission;

5) Several neighboring devices may advertise the provision of their context information by Tow-power LCPC;

6) The Source MD may select one or more of the neighboring devices (for example the one with the lowest answering latency) and may request submission of context information by low-power LCPC;

7) The selected neighboring device may provide context information and multi-hop related information (willingness to act as relay node, node degree, etc.) by low-power LCPC;

8) The Source MD may select the most suitable communication mode based on the context information that may be now available. If multi-hop communication is possible, the Source MD may compare the communication cost of a direct MD-BS communication (in terms of cost, latency, . . . ) to a relay-based communication (which may reduce the power consumption due to communication with close-by MDs which may act as relays).

In various embodiments, steps 5 and 6 may be skipped. In this case all Source MDs that received the request of step 4 may provide the requested information as described in step 7.

As explained above, the low-power LCPC may be only one option. Sending out requests and receiving context information via a base station/access point may be another option.

It will be noted that the LCPC may co-exist with other realizations of a cognitive pilot channel (CPC), for example commonly used standard CPC.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. An end-user mobile device, comprising
a transmitter configured to broadcast context information based on the occurrence of a pre-determined event.

2. The end-user mobile device of claim 1, further comprising:
a wireless receiver configured to wirelessly receive a request to request the end-user mobile device to broadcast the context information;
wherein the pre-determined event is the reception of the request to request the end-user mobile device to broadcast context information.

3. The end-user mobile device of claim 1, further comprising:
a timer configured to time a pre-determined time;
wherein the pre-determined event is the expiration of the timer.

4. The end-user mobile device of claim 1,
wherein the broadcasted context information comprises information identifying a radio access technology available at the location of the end-user mobile device.

5. The end-user mobile device of claim 2,
wherein the request comprises a hop number indicating the number of hops the request has been relayed from its originator.

6. The end-user mobile device of claim 5, further comprising:
a maximum hop determiner configured to determine whether the hop number is below a hop number threshold, and
wherein the transmitter is configured to broadcast the context information only if the maximum hop determiner determines that the hop number is below a hop number threshold.

7. The end-user mobile device of claim I, further comprising:
an estimator configured to estimate the number of other mobile devices in the vicinity of the end-user mobile device; and
a power regulator configured to regulate the transmission power, with which the context information is broadcasted, based on the estimated number of other mobile devices in the vicinity of the end-user mobile device.

8. An end-user mobile device, comprising:
a wireless transmitter configured to wirelessly transmit a request to request an other end-user mobile device to broadcast context information; and
a receiver configured to receive the broadcast context information.

9. The end-user mobile device of claim 8, further comprising:
a task assigner configured to assign a task out of a plurality of tasks to the other end-user mobile device;
wherein the request comprises information identifying the task.

10. The end-user mobile device of claim 8, further comprising:
a route guidance system interface configured to acquire route information of the end-user mobile device from a route guidance system.

11. The end-user mobile device of claim 10, further comprising:
a forecaster configured to forecast operating conditions at the end-user mobile device based on the received broadcast context information and the acquired route information.

12. A method for controlling an end-user mobile device, comprising:
broadcasting context information based on the occurrence of a pre-determined event.

13. The method of claim 12, further comprising:
receiving a request to request the end-user mobile device to broadcast the context information;
wherein the pre-determined event is the reception of the request to request the end-user mobile device to broadcast context information.

14. The method of claim 12, further comprising:
timing a pre-determined time;
wherein the pre-determined event is the expiration of the pre-determined time.

15. The method of claim 12,
wherein the broadcasted context information comprises information identifying a radio access technology available at the location of the end-user mobile device.

16. The method of claim 13,
wherein the request comprises a hop number indicating the number of hops the request has been relayed from its originator.

17. The method of claim 16, further comprising:
determining whether the hop number is below a hop number threshold, and
broadcasting the context information only if it is determined that the hop number is below a hop number threshold.

18. The method of claim 12, further comprising:
estimating the number of other mobile devices in the vicinity of the end-user mobile device; and
regulating the transmission power, with which the context information is broadcasted, based on the estimated number of other mobile devices in the vicinity of the end-user mobile device.

19. An method for controlling an end-user mobile device, comprising:
wirelessly transmitting a request to request an other end-user mobile device to broadcast context information; and
receiving the broadcast context information.

20. The method of claim 19, further comprising:
assigning a task out of a plurality of tasks to the other end-user mobile device;
wherein the request comprises information identifying the task.

21. The method of claim 19, further comprising:
acquiring route information of the end-user mobile device from a route guidance system.

22. The method of claim 21, further comprising:
forecasting operating conditions at the end-user mobile device based on the received broadcast context information and the acquired route information.

23. A communication system, comprising:
a first end-user mobile device and a second end-user mobile device,
wherein the first end-user mobile device comprises:
a wireless receiver configured to wirelessly receive a request to request the end-user mobile device to broadcast context information; and
a transmitter configured to broadcast the context information; and
wherein the second end-user mobile device comprises:
a wireless transmitter configured to wirelessly transmit a request to request an other end-user mobile device to broadcast context information; and
a receiver configured to receive the broadcast context information.

24. A method for controlling a communication system comprising a first end-user mobile device and a second end-user mobile device, the method comprising:
wirelessly receiving in the first end-user mobile device a request to request the first end-user mobile device to broadcast context information;
broadcasting from the first end-user mobile device the context information;
wirelessly transmitting in the second end-user mobile device a request to request an other end-user mobile device to broadcast context information; and
receiving in the second end-user mobile device the broadcast context information.

25. A communication device, comprising:
a transmitter configured to broadcast context information based on a wirelessly received request.
